(19) United States
(12) Patent Application Publication
(10) Pub. No.: US 2022/0043973 A1
(43) Pub. Date: Feb. 10, 2022

(54) CONVERSATIONAL GRAPH STRUCTURES

(71) Applicant: Capricorn Holding Pte Ltd., Singapore (SG)

(72) Inventors: Sinuhé Arroyo, Singapore (SG); Carlos Ruiz Moreno, Madrid (ES); Guillermo Infante, Singapore (SG)

(21) Appl. No.: 16/985,101

(22) Filed: Aug. 4, 2020

(51) Int. Cl. G06F 40/237; G06F 40/284; G06F 3/0484; G06F 3/0486; G06F 16/901; G06F 9/451

(52) U.S. Cl. CPC G06F 40/237; G06F 40/284; G06F 9/451; G06F 3/0486; G06F 16/9024; G06F 3/04847

(57) ABSTRACT

A system and method for executing a node within the conversation graph model by receiving from a client device, a user input, and executing a first software instruction in the node, based on the user input. A server may identify at least one token within the user input, and if it matches a conversation context data associated in a database with the at least one token: suspend execution of the first software instruction; identify an abstract node associated in the database with the conversation context data; identify a specialized node associated in the database with conversation context data and the abstract node; and execute a second software instruction within the specialized node.

### FIELD OF THE INVENTION

The disclosure relates in general to an electronic system for providing a user interface allowing a user to interact with a computer system and, more particularly, to a method and apparatus for designing and implementing a conversation graph, which may be traversed by a user, in a linear or non-linear fashion, to receive information from the system and input user-specific data which is then processed as the conversation proceeds.

### BACKGROUND

In situations where a human user wants to interact with a computer system using natural language, the computer system designers, programmers, and/or administrators may provide an automated dialog software, allowing users to interact with the system, as if they were having a human-to-human conversation, in either written or spoken format. In many instances, the use of natural language in interacting with the automated dialog software allows the user to interact with the automated dialog software in an environment in which the user is most comfortable. This automated dialog software may therefore allow a human user to conveniently access the system's functionality and stored data in a familiar environment, during which they may engage in a spoken or written conversation.

### BRIEF SUMMARY

The disclosure relates in general to an electronic system comprising a database and a server. The database may store: a model comprising an ontology; a conversation graph model; and at least one conversation instance. The server may comprise a computing device coupled to a network and comprising at least one processor executing instructions within a memory. When the instructions are executed, they may cause the system to: receive, from a client device, a request to execute a conversation graph; select the conversation graph model from the database; execute a node within the conversation graph model, an execution of the node comprising: generating a Graphical User Interface (GUI). The GUI may further comprise: a first GUI component displaying a content; and a second GUI component receiving, from a user, a user input; transmitting the GUI to the client device for display. The execution of the node may further comprise receiving, from the client device, the user input, and executing a first software instruction in the node, based on the user input. The server may further be configured to identify at least one token within the user input, and responsive to the at least one token matching a conversation context data associated in a database with the at least one token: suspend execution of the first software instruction; identify an abstract node associated in the database with the conversation context data; identify a specialized node associated in the database with conversation context data and the abstract node; and execute a second software instruction within the specialized node.

### BRIEF DESCRIPTION OF THE DRAWINGS

FIG. 1 is a block diagram illustrating one example configuration of the functional components of the present conversational graph structure system.

FIG. 2 is a screen shot illustrating one example configuration of the present system, allowing a user to design and create a conversational graph model.

FIG. 3 is a screen shot illustrating one example configuration of the present system, allowing a user to interact with a software system.

FIG. 4 is a flowchart showing method steps for instantiating and executing a conversation graph structure.

### DETAILED DESCRIPTION OF THE DRAWINGS

This invention is described in embodiments in the following description with reference to the Figures, in which like numbers represent the same or similar elements. Reference throughout this specification to “one embodiment,” “an embodiment,” “one implementation,” “an implementation,” or similar language means that a particular feature, structure, or characteristic described in connection with the embodiment is included in at least one embodiment of the present invention. Thus, appearances of the phrases “in one implementation,” “in an implementation,” and similar language throughout this specification may, but do not necessarily, all refer to the same embodiment.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Any schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

In an automated dialog software environment described above, it is impossible to anticipate how each individual user may interact with an automated dialog software within a computer system, or respond to prompts provided by such a system.

For example, typically, in human-to-human interaction, one person may abruptly change topics or direction within the dialog of a conversation. When designing, programming, building and implementing automated dialog software systems, it is difficult to mimic such sudden changes in conversation. The design and implementation for such a system may require programming the system to understand a human user, identify sudden changes in the direction or context of the conversation, and respond to these sudden changes. Currently existing dialog software systems are unable to identify changes in the direction or context of the conversation and respond to the user accordingly. Currently existing system are also unable to handle associated errors related to such misunderstandings.

The disclosed embodiments are specifically designed to understand users, interpret human user input during virtual conversations, identify and maintain the context of conversations according to changes in the conversation, and handle error situations where misunderstandings may occur.

Specifically, the disclosed embodiments include a method and system allowing a user to design one or more conversation graphs, including: conversation graph nodes that handle user interaction with the system and sudden context changes introduced by human users; graph edges that connect one or more graph nodes in linear/conditional embodiments; and non-linear embodiments that identify conversation context changes and navigate to appropriate graph nodes.

The system may therefore include one or more user interfaces for the design and implementation of a conversation graph, as well as an ontology that defines the concepts behind the graph components and includes semantics that define the rules for relationships between the concepts in instances of conversation graphs.

The disclosed embodiments further provide a system for implementing instances of the designed conversation graphs, thereby allowing a user to interact with them. During the implementation of such conversations, the disclosed systems and methods identify and maintain conversation contexts and node states, which may be data items, either within the nodes or global to the conversation graph, that influence and guide the conversation behavior, and handle conversation error situations in real time.

All methods and steps described herein may be performed by any central processing unit (CPU) or other processor in a computer or computing system, such as a microprocessor running on a server computer 110, and executing instructions stored (perhaps as applications, scripts, apps, and/or other software) in computer-readable media accessible to the CPU or processor, such as a hard disk drive on a server computer 110, which may be communicatively coupled to a network 100 (including the Internet). Such software may include server-side software, client-side software, browser-implemented software (e.g., a browser plugin), and other software configurations.

In the interest of simplicity in describing the execution of method steps or other software instructions, such as node processing, disclosed herein, the instant disclosure refers to a “server” 110. However, it should be understood that reference to a server 110 in this context is for simplicity only, and that the disclosed method steps may be accomplished by any components within the technological environment disclosed and described herein. As non-limiting examples, the method steps may be accomplished by any combination of a server 110, multiple servers 110, a client 120 or other user device, such as a desktop, laptop, mobile phone, tablet device, wearable media, etc., or by any other computer hardware or software described herein or known in the art.

The disclosed embodiments include the design, implementation (e.g., creation of an instance of), and execution of one or more conversation graphs, which may include any form of graph. As a non-limiting example used in the disclosed embodiments, the graph used to design, implement, and execute a conversation may include a tree graph including conversation graph nodes and conversation graph edges.

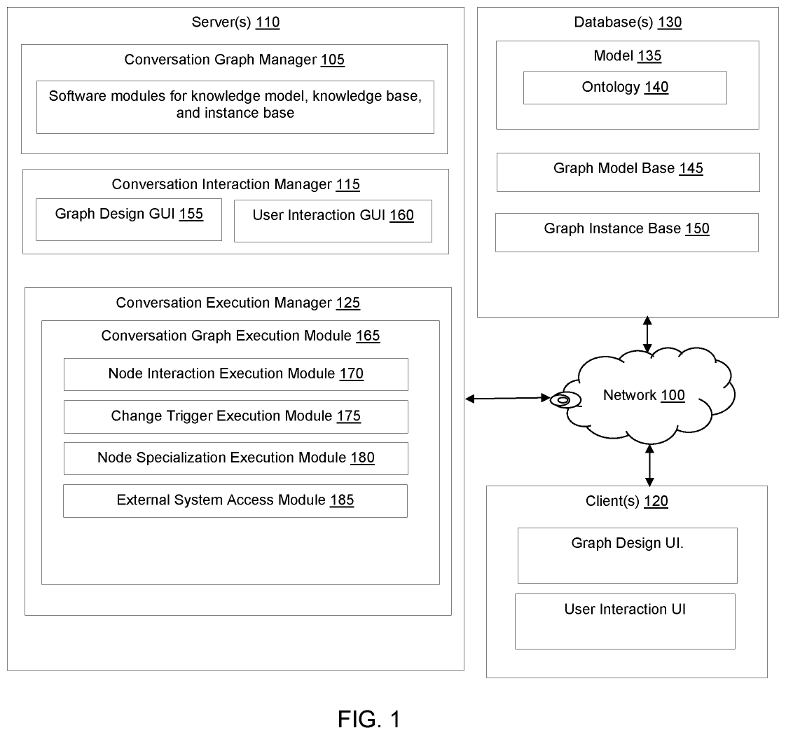

As seen in FIG. 1, the disclosed embodiments may include one or more software modules running on one or more servers 110, including one or more conversation graph manager software modules 105, one or more conversation interaction manager software modules 115, and one or more conversation graph execution manager software modules 125.

As further seen in FIG. 1, the disclosed system may include a database 130. It should be noted that although data used by the server 110 and described below, such as the ontology 140, the model 135, the graph model base 145, the graph instance base 150, and other data herein, is represented as being stored in database 130, the instructions, data, models, relevant file or content, etc. may be stored and/or executed in any memory within the system. Thus, this data may be available within any combination of one or more files stored on a hard drive or active memory of server 110 and/or client 120, or within software instructions or logic (e.g., node processing) within any of the software modules described herein, as non-limiting examples.

As further seen in FIG. 1, the conversation graph manager 105 may access and run various method steps using data from a model 135, also referred to herein as a knowledge model. As demonstrated in FIG. 1, this model 135 may further contain a conversation graph ontology 140.

The ontology 140 used in the disclosed embodiment is a non-limiting example. Any representation of a formalization of concepts and relationships, used for semantic clarity and precision, may be substituted for the ontology 140 disclosed herein. In the disclosed embodiments, ontology 140 may define the semantics used in association with conversation graphs. These semantics may include, as non-limiting examples, concepts, relationships, and/or instances used to define a conversation graph model, also referred to herein as a conversation graph design, definition, type, concept, template, pattern, and the like.

As non-limiting examples, the concepts, relationships, and/or instances associated with the conversation graph may include the graph itself, a node, edge, condition, context, trigger, etc. used to design the graph. Concepts may further include various specializations of other concepts. As a non-limiting example, the concept of a subgraph may be a specialization of the concept graph, the concepts of start nodes, end nodes, and error nodes may be specializations of the concept node, and so forth. In embodiments described in more detail below, a conversation context (one or more data items within a data structure, which are globally available to the entire graph, and which may, for example, describe a node state) may also be associated with the graph concept.

Non-limiting examples of concepts may therefore include: conversation-graph, conversation-graph-node, start-node, end-node, error-node, conversation-graph-edge, condition, and conversation-graph-context. Non-limiting examples of relationships may include: is-part-of (e.g., conversation-graph-node is-part of conversation graph); is-a (e.g., start-node is-a conversation-graph-node, end-node is-a conversation-graph-node, error-node is-a conversation-graph-node—since special nodes like start nodes, end nodes or error nodes are specializations of conversation-graph-node); has-source-node (e.g., conversation-graph-edge has-source-node conversation-graph-node); has-target-node (e.g., conversation-graph-edge has-target-node conversation-graph-node); has-condition (e.g., conversation-graph-edge has-condition condition; start-node has-condition condition); has-context (e.g., conversation-graph has-context context; is-default-start-node (e.g., conversation-graph-node is-default-start-node graph); is-default-error-node (e.g., conversation-graph-node is-default-error-node conversation-graph); is-default-edge (e.g., conversation-graph-edge is-default-edge conversation-graph-node); and so forth.

It should be noted that a conversation graph model is distinct from a conversation or conversation graph instance, in that the conversation graph model is the result of the design of the conversation graph, and each conversation graph instance represents an ongoing or previously recorded conversation with a user. It should further be noted that node instances, edge instances (which connect source and target node instances), and conditions (where applicable and described below, associated with edge instances) are part of a graph instance. By having instances of a conversation graph model (or definition, type, concept, template, pattern, etc.), independent instances of graph models (i.e., conversations) can occur simultaneously, each following the same conversation graph model.

The conversation graph ontology may include one or more concept extensions, allowing for conversation change triggers and graph node abstraction and specialization concepts, described in more detail below.

Regarding conversation change triggers, one of the concepts associated with the conversation change trigger may include an input match criteria, used to determine if user input includes one or more keywords associated with a conversation context. Another concept may include a concept change directive, including instructions related to a change in conversation context. The relationships to properly relate all of the conversation change trigger concepts (e.g., change trigger, input match criteria, context change directive) may therefore need to be added to the conversation graph ontology.

Non limiting examples of concepts for a conversation change trigger may include conversation-graph-trigger, user-input-match-criteria, and context-change-directive. Non-limiting examples of relationships for a conversation change trigger may include: has-criteria (conversation-graph-trigger has-criteria match-criteria); has-directive (conversation-graph-trigger has context-change-directive); and refers-to (conversation-graph-trigger refers-to node).

Another extension within the conversation graph ontology may include extensions for the introduction of graph node abstraction and specialization concepts, associated with graph node abstractions and specializations and described in more detail below. These extensions may include the concept of a specialized node, the concept of a specialized node being a node, and specialized nodes related to conditions that access the conversation context.

Non-limiting examples of concepts for node abstraction and specialization may include specialized-node. Non-limiting examples of relationships for node abstraction and specialization may include specialized-node has-condition condition, and specialized-node is-a node.

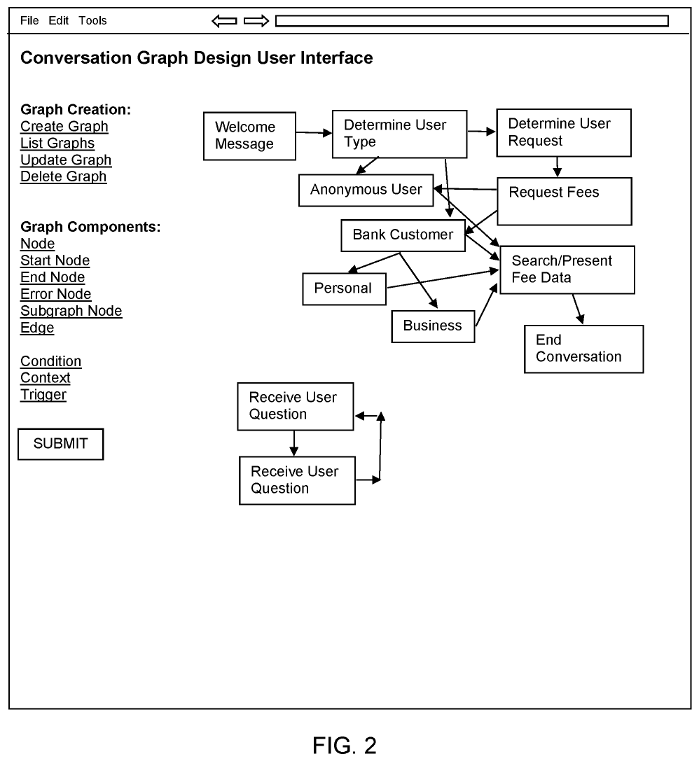

As seen in FIG. 1, and in the non-limiting example seen in FIG. 2, the conversation graph manager 105 may access and run various method steps using conversation graph model data (also referred to as conversation graph design, definition, type, concept, template, and/or pattern data) from a conversation graph model database 145, also referred to as a conversation graph knowledge, definition, type, concept, template, and/or pattern database. This conversation graph model database 145 contains the conversation graph models that are complete or currently in the process of being designed, which are then stored and used by the disclosed system to generate instances of conversation graphs based on the stored ontology, in order to implement a specific conversation.

As further seen in FIG. 1, the conversation graph manager 105 may use the ontology and the conversation graph models to implement specific instances of the conversation graph model as specific conversations, and may store a history of the ongoing or completed graph instances/conversation within a conversation instance database 150. The conversation instance database 150 therefore contains ongoing conversation graph instances, which have been, or are currently being executed, according to a specific conversation graph model in the conversation graph model database 145. The conversation instance database 150 may further store a history of one or more conversation/graph model instance executions, including past and current instances.

As further seen in FIG. 1, the disclosed system may include one or more conversation interaction manager software modules 115. The conversation interaction manager software modules 115 may further include one or more graph design Graphical User Interface (GUI) software modules 155, and one or more user interaction GUI software modules 160.

It should be noted that although graphical user interfaces are demonstrated in the disclosed embodiments, any type of interface may apply. As a non-limiting example, the data exchanged via one or more GUIs in the disclosed embodiments would also equally apply in a scenario in which the data is accessed and/or exchanged via an application programming interface (API).

The graph design GUI software 155 may be used to create conversation graph models. These conversation graph models may represent a visualization of graph patterns within a conversation, and may be customizable for the implementation of a graph. The graph design GUI software 155 may also graphically provide the tools (e.g., pallets, drawing tools, layout tools, etc.) and functionality for a conversation graph designer to create conversation graph models.

In the non-limiting example embodiment seen in FIG. 1, the graph design GUI generated by the graph design GUI software 155 may include one or more GUI components (e.g., links, as shown in FIG. 2, buttons, dropdown boxes, etc.) configured to generate and transmit a user request to Create, Read/list, Update, or Delete (CRUD, as used in RESTful APIs) a conversation graph model. Using the Create command as a preliminary non-limiting example, the user's client device 120 may then transmit a Create request through network 100 to server 110, which may execute the software instructions described below.

In response to the Create request, the graph design GUI software 155 running on server 110 may access ontology 140 within model 135 to identify concepts and relationships needed by a conversation graph designer to generate a conversation graph model. Using the concepts in the ontology 140, the graph design GUI software 155 may then generate GUI components and other means of user input used by the conversation graph designer to create the conversation graph model. As seen in FIGS. 1 and 2, non-limiting examples of such GUI components may include nodes (e.g., start nodes, end nodes, error nodes, subgraph nodes, etc.), edges, conditions, contexts, and triggers, each of which will be described in detail below.

A node within a conversation graph denotes the state of a user conversation within a conversation graph. In some embodiments, only one node may be active within the conversation graph at a time. In some embodiments, such as the linear and/or conditional conversation graph described below, nodes may be connected by an edge. Each of the connected nodes may therefore be a source node or a target node, as described below.

Each node in the conversation graph may include an inner structure including code (which contains node processing instructions) and state. The processing instructions within the internal structure of the node may include execution semantics to provide node functionality through node processing. These processing instructions may be implemented using any scripting or programming language known in the art.

The node processing instructions may be configured to execute the code within the inner node structure, which results in node processing. In some embodiments, this node processing implements interaction with a user. This interaction may be accomplished by providing information to the user by displaying the output of the processing (e.g., greetings, instructions, or questions for the user), and receiving input from the user. The node processing may then process the input or other information received from user, and display output based on node processing result. If there are additional instructions, the node may repeat the node processing steps (e.g., continued interaction with user) if necessary. Once all instructions have been executed, the node may finalize node processing, by declaring node processing to be finished. Once the node processing has been finalized, it cannot resume or continue.

As noted above, each node may have a state, which may be made up of a data structure including defined data items (e.g., local state variables) accessible to the node processing instructions described above. The scope of the state (and the associated data items) may be public or private, much like variables within certain code blocks (e.g., a software object class, functions, if/then/switch statements, etc.), and therefore may be visible, or not visible externally, to other nodes and edges outside of the current node's processing.

A conversation graph designer may create conversation graph models, and these conversation graph models may be implemented using multiple steps within a single node, using multiple nodes, or any combination thereof, according to the designer's discretion. The use of several nodes in the conversation graph model provides flexibility for extension and adjustment.

A conversation graph model may include one or more start nodes. When a conversation is instantiated, one or more conditions (e.g., a determination of whether a particular start node evaluates to true) may identify a start node among multiple start nodes, for that instance of the conversation model. If none of the start nodes evaluates to true, the graph model must include a default start node, ensuring that every conversation has a start; otherwise, an error may occur. Each node in a conversation graph model must be at least implicitly and/or transitively reachable from a start node, except for the start node itself, which in some embodiments may be unreachable by other nodes.

A conversation graph model may include one or more end nodes. If the end node is reached, any transition between nodes within the conversation graph ends. Any node processing instructions within the end node are executed, but once this node processing is complete, graph execution ends, and the conversation is concluded. Multiple end nodes within a graph model are possible, but in some embodiments, the graph model may include only one end node.

A conversation graph model may include one or more error nodes, so that error handling may be specified within the graph definition. These error nodes are executed when no other change in the conversation graph is possible, and an end node has not been reached within the graph. The execution of an error node may include its own internal processing, which may affect the graph (e.g., the state and/or context of the graph, described herein).

The graph model may include at least one default error node. Each node in the graph model is implicitly connected to this default error node, in order for the default error node to be reachable by every non-error node. Each of these non-error nodes may further be implicitly connected to the default error node.

The graph model may include at least one additional (“defined”) error node. These defined error nodes may be created by a conversation graph designer as needed. Each of the defined error nodes may be defined in such a way as to handle specific conversation error situations relative to a node. The defined error nodes may therefore be explicitly connected by an explicit edge to the specified node, which may be explicitly labeled as an edge to a defined error node. When the specified error occurs, the defined error node may take precedence, and be chosen, over a default error node. As a result, the conversation path will follow the explicitly defined edge to the defined error node, rather than the implicitly defined edge to the default error node.

In some embodiments, the node processing within error nodes may change the current (e.g., error) state within the conversation graph, which may return the conversation graph to its normal processing state. These error nodes may be connected to the conversation graph by one or more outgoing edges to non-error nodes. The error node may execute its instructions, resulting in node processing to recover from the error, and if successful, resume normal processing. In this case, the outgoing node continues graph execution by following the identified outgoing edge from the error node to a regular, non-error node. If the error cannot be addressed and/or resolved by the error node, the conversation can be concluded by following an outgoing edge to an end node.

As demonstrated above, and in embodiments that include linear or conditional graph traversal, the conversation graph model may include edges that connect nodes. In some embodiments, a directed edge connects exactly two nodes. The edge is therefore an outgoing edge from a source node, also referred to as an origin node, and is also an incoming edge to a target node, also referred to as a sink node. It should be noted that the source node and the target node cannot be the same node.

In embodiments that include linear and/or conditional graph traversal, one node can have several outgoing edges, each associated with its own condition within the node instructions/processing. As noted above, each node also has a state. The condition associated with each outgoing edge may access the public state of the source node after node processing is complete, in order to evaluate the condition. Because conversations implemented using the graph are single threaded in some embodiments, the condition of only one edge amongst all outgoing edges must be fulfilled. When node processing is complete, this condition determines the outgoing edge of the source node, based on the condition.

In order to respond to a situation in which no condition of any outgoing edge evaluates to true, or is otherwise fulfilled, a default edge may be defined within the graph model. This default edge does not have a related condition. In addition, as noted above, every node in the conversation graph may be connected to a defined or default error node. If the default edge is unsuccessful in reaching the target node, the default error node for the conversation graph may be selected as a last resort.

A conversation graph model may further include one or more conversation contexts. These conversation contexts may influence and guide the conversation behavior, specifically the direction of a conversation, by selecting different paths through the conversation based on the defined context.

A conversation context may include a data structure that exist within linear/conditional graphs models and within non-linear graphs models (described below). The data structure may further include a set of data items that are relevant to the conversation, and the context associated with these data items may change as the conversation progresses. The data items may be of any type (e.g., start time/date, country/time zone of the conversation, login status of a user, etc.), and each data item may be assigned a value (e.g. respectively, 11:59 PM 1/1/2000, “Eastern Central Time, United States,” “logged in private user,” etc.). The data items, and their associated values may be created/added, read, updated, and/or deleted at any point in the conversation graph/instance, which may then reflect a change in the conversation context, and may be stored within the conversation history, described below, possibly within the graph instance base 150.

Each value associated with a context data item may be set, retrieved, and/or changed, by node processing. In some embodiments, node processing logic may depend on the values stored in association with the data items in the context data structure, resulting in the node processing, and by extension the resulting user interactions, changing according to changes in the context. In other embodiments, node processing related to user interaction may be independent of context.

The data items and values within the context data structure may be global in scope. In other words, the data items and values within the context data structure may be available, accessible, and/or visible to all graph components (e.g., nodes and edges) within the conversation graph and/or conversation instance.

In embodiments that include linear/conditional node processing, the conditions identified within the node processing, as well as the result of those conditions may, but don't necessarily, affect the conversation context. Conversely, the conversation context may affect the conditions and the result of the conditions, (e.g., a determination of which of multiple edges to follow from the source node). As a non-limiting example, a conversation context change may be noted within a public data item (possibly a public node state) in the conversation context data structure, allowing the edge condition evaluation to incorporate the change, and further allowing subsequent nodes and edge conditions to access it.

Conversation graph models may be configured to detect a conversation change and react to it. The conversation graph designer may therefore decide how to detect and/or determine a significant change, and how the conversation model should react to it. As a non-limiting example, the conversation graph model may be designed to suspend node processing at a first node, and continue the conversation at a different node. Specifically, once a significant conversation context change has been detected, the conversation graph designer may decide whether the node processing continues with the current node or if the conversation should continue at another, different node in the conversation graph model. If the context change is relevant to the ongoing node processing, it may adjust or change the node processing flow to reflect the change. If not, however, node processing may continue to completion, as before.

In response to the detection of a conversation change, the conversation graph model may specify a conversation change trigger. A conversation change trigger may affect the conversation graph based on user input. The system may analyze such user input, and the change trigger may intercept node processing within a current node, may pause, suspend or stop the processing in the current node and, if the analysis of the user input indicates that the change trigger should be fired (e.g., if keywords within the user input match keywords associated in the database with a specific context via a user input match criteria), the system may immediately continue at a different, separate node.

In some embodiments, the conversation change trigger consists of three parts: First, the conversation change trigger may include a user input match criteria, to match one or more string tokens in the user input to context data stored in database 130. In some embodiments, this matching algorithm may include a calculation of a confidence value, described in more detail below. Second, the conversation change trigger may include an optional conversation context change directive, specifying a change in conversation context, and adding, updating or deleting one or more data items in the conversation context. Third, the conversation change trigger may include an optional graph node reference, specifying an existing graph node in the conversation graph, such as a regular node, subgraph node, error node, end node, and so forth, selected at the designer's discretion, and used to continue node processing if the change trigger fires. These three elements of any conversation change trigger may be stored in association in database 130.

The conversation graph designer may use the concepts of conversation change triggers and default nodes to design and implement an entire conversation in a non-linear way—as a set of conversation change triggers and default edges. Although they may be considered linear or conditional, the use of default edges provides a means to continue the conversation if there are no applicable conversation change triggers, requiring an evaluation of various conditions to navigate to a next node. In other words, a default edge ensures that there is always a next node that can be selected within the graph model.

To summarize the concept of non-linear graph traversal, rather than designing a graph organized to include conversation graph logic based on conditional branching inside node processing, and to be traversed in a linear way based on the results of conditional analysis, the graph may be designed to detect context change triggers and traverse the graph according to the change trigger instructions and graph node references.

In some embodiments, the graph node reference may specify a single node to which to navigate if a change trigger is fired. Alternatively, in some embodiments the graph node reference may include multiple possible nodes to be navigated to if the change trigger is fired.

In embodiments that include multiple possible nodes to be navigated to if the change trigger is fired, node abstraction and specialization may support different selections and implementations of a node, dependent on the conversation context. In other words, instead of conditional graph node processing based on the conversation context, several graph nodes may be specified that are specializations of an abstract node and are selected based on the conversation context via a condition.

In these embodiments, the design of non-linear conversation graphs may implement such abstraction and specialization, where the logic of each branch becomes a separate node specialized for a single case. This abstraction and specialization may include abstract nodes and specialized nodes. Each specialized node may relate to a condition that evaluates the conversation context and determines if that specialized node is to be executed or not. There may be many conditions and specialized nodes and only one condition must evaluate to true. Each of the possible separate nodes is related, possibly in the ontology, with an abstraction/specialization relationship, wherein each of multiple specialized nodes “is-a[n]” abstract node. If no condition evaluates to true, an error may occur, and the error edge is followed to an error node.

The conversation context data may include one or more items used to select the specialized nodes based on a condition. The specialized nodes may therefore be selected based on one or more values associated with these items and the specialized nodes in the conversation context data.

In a non-limiting example using a banking application, the conversation graph model may include an abstract node titled “Provide Fee Schedule.” A conversation context may include a data item called “user type,” and this data item may be associated with three possible values: “anonymous”, “private_customer” or “business_customer.” The conversation graph model may therefore include three specialized nodes, each associated with one of the specialized values, and titled, respectively “Provide Fee Schedule for Anonymous User”, “Provide Fee Schedule for Private Customer” and “Provide Fee Schedule for Business Customer.” The condition for the “Provide Fee Schedule for Anonymous User” may be expressed “user_type==anonymous”. The conditions for the other two nodes may be expressed “user_type==private_customer” and “user_type==business_customer,” respectively.

The conversation graph model may further include one or more subgraphs. As seen in FIG. 2, as more nodes and edges are added to a graph, it can become very complex. To avoid such complexity, the disclosed embodiments include the concept of a subgraph—a graph with one non-conditional start node independent of the original start node, and one end node independent of the final end node.

Within a conversation graph design GUI, the design of the subgraph may be separate from the design of its parent graph, and may be represented as a single node within the “parent” conversation graph, so that the subgraph is executed instead of node processing for that node. Representing a subgraph as a single node reduces complexity to the conversation graph, and there is no limit on the complexity that may exist within the subgraph—any graph structure described herein may exist between the subgraph start and end nodes. The subgraph itself (and any “children” subgraphs) may further have nodes representing any additional subgraph “children,” and so forth.

In embodiments where the conversation graph model includes a subgraph (described below), the context may be passed to the subgraph, and returned from a subgraph, though possibly changed. The context is therefore globally visible regardless of subgraph execution.

Any designed conversation graphs may be saved, as either an intermediate or complete design, in the conversation graph model base 145, or anywhere within database 130, at any time.

As seen in FIG. 2, the conversation graph design GUI may further include additional GUI components (e.g., links or buttons), configured to read, update, or delete conversation graph models. On submission of any of these commands from the conversation graph design GUI 155, the appropriate request may be sent through network 100 to server 110, which may process the request and execute the appropriate software instructions to complete the command.

Returning to FIG. 1, the conversation interaction manager may further include a user interaction GUI 160. This conversation interaction manager GUI 160 may communicate with the conversation graph execution component to implement graph model implementation. In some embodiments, this user interaction GUI 160 may be the default user interface configured to initiate conversations with the end user, display information to the user and receive user input from the user. Based on any combination of results from node processing and received user input, the system may traverse the graph and execute any node processing based on input with the end user. The end user may further suspend or to terminate conversations.

Returning to FIG. 1, server 110 may execute one or more conversation execution manager software modules 125, which may receive a request to begin a conversation, select a conversation graph model from conversation graph model base 145, and execute an instance of the selected conversation model. In some embodiments, execution of the graph instance is single threaded, meaning that only one conversation in a single conversation graph instance is executed at a time. In addition, only one node is active within each conversation design instance, and the conversation flow follows only one edge at a time in linear or conditional embodiments. In view of this single threaded nature of the disclosed embodiments, each conversation comprises a linear execution of nodes, in a series, and the order of this series is determined by the nodes selected and executed based on graph traversal. However, embodiments could be conceived in which several active paths exist through a conversation graph instance concurrently (e.g. by maintaining a separate and independent state for each active path). It is therefore technically possible to implement such a system, but in the disclosed embodiments, if a user wants to engage in two concurrent conversations, the user would need to create and trigger two separate conversation graph instances, rather than two concurrent paths within the same conversation graph instance

As demonstrated in FIG. 1, the conversation graph execution manager software 105, possibly one or more conversation graph execution modules 125 may be responsible for the creation and execution of conversation graph instances. As a preliminary step, a user may access a user interface, possibly user interaction GUI 160, and transmit a request to initiate a conversation. The conversation graph execution module 125 may then respond to requests coming from the user interaction GUI 160.

As a non-limiting example, in response to the user requesting a conversation, server 110 may dynamically interpret the request, analyze the request to identify a conversation graph model in the conversation model base 145 (possibly according to conversation graph concept).

The conversation graph execution module 125 may then create an instance of the selected conversation model. An instance of a conversation graph model may represent an ongoing or previous conversation between a user and the disclosed system. Independent conversations/instances of the same conversation design may be used to interact with many different users simultaneously.

Once a conversation graph instance is created, server 110 may store all data associated with the instance into conversation graph instance base 150. Each subsequent action taken on the graph instance, as well as all associated variables, states, contexts, nodes, edges, etc. may also be stored in the conversation graph instance base 150.

Once a conversation graph model has been selected, execution starts at a single start node within the selected graph. The single start node may be selected from one or more start nodes selected by server 110 from within the conversation graph model. Server 110 may evaluate the condition(s) of each start node to determine which node's condition evaluates to true, indicating the default start node to begin the instance of the conversation graph. Server 110 may then create an instance of the start node from the conversation graph model, and execute the node processing instructions within the identified start node.

During the execution of the start node, and all subsequent nodes, the user interaction GUI 160, possibly one or more node interaction execution software modules 170, shown in FIG. 1, may manage user interaction and the node's state within the disclosed system. Using these software modules, each node in a conversation graph may therefore interact with the end user. The node interaction may include displaying information to the user, possibly on user interaction GUI 160. This displayed information may include a prompt, requesting information via user input from the user. The user may then input the requested information (or may indicate changes in context, state, etc., described herein), and submit the information, through network 100 to server 110.

Server 110, and possibly node interaction execution software module 170, may receive the user input, and execute node processing for the appropriate node before and after any interaction with the user, to generate output for additional node processing and/or user interaction (possibly additional input) from the user.

In embodiments that include conditional, linear processing the node processing may include comparing the user input with one or more conditional statements (e.g., if/then, switch statements) that test the state of internal variables based on the user input. The condition is evaluated once node processing on the source node is finished.

In linear/conditional embodiments, after node processing is finished, server 110 may evaluate the conditions of all outgoing edges, and choose the edge that evaluates to true, as the edge that should be followed to a connected target node. To accomplish this, edge conditions for all edges associated with the current node may have access to the node's public state and conversation context, based on their associated data items. Server 110 may select edges in accordance with the public node state or the conversation context. Only one edge may evaluate to true. If more than one edge evaluates to true, the system triggers an error node. Server 110 may instantiate a target node associated with the edge that evaluates to true, and the target node may begin node processing by executing the software instructions for the target node.

If none of the edges evaluate to true, a default edge within the conversation graph model may be identified (if it exists) and followed to a default target node. If no default edge exists within the graph, then the graph execution transitions to a defined, or default, error node.

The node processing within nodes described herein may be repeated for each node. In linear/conditional embodiments, this may include finding an edge with a condition that evaluates to true, choosing the identified edge, instantiating the target node, and executing node instructions, until an unresolvable error node or an end node is reached within the conversation graph. Node processing may be repeated as many times as necessary and/or may be altered according to additional user input (e.g., a user may ask multiple questions and the node processing may generate responses, in a Q&A node).

If no defined error node exists then the default error node for the conversation graph is selected as a last resort. The default error node of the conversation graph must be specified.

A significant change in the conversation context may change not only the processing of individual nodes, but may change processing within the graph as well. As noted above, the system may store context data generated from user input and/or node processing, and access it via detection of public node state and/or conversation context. In these embodiments, rather than defining edge conditions based on all possible conditions to determine an outgoing edge from node state or context values based on user input values, some disclosed embodiments may use nonlinear conversation graph execution to simplify graph traversal by pausing a current node, and continuing the conversation in another part of the graph, as described herein. Nonlinear conversation graph execution is therefore based on the concepts of a change or switch to the conversation context, and uses a conversation change trigger to respond accordingly.

The system may identify significant changes in the context of the conversation based on user input. As a non-limiting example, during a conversation with a bank system, a user may log into the system, changing their context/state from an anonymous user to a bank member user. In some embodiments, node processing in the current node may be suspended or ended, and resumed in an unrelated node.

A conversation change trigger may comprise logic in the disclosed system to change the conversation and to continue at a separate graph node without having to implement complex conditional logic using public graph state values and/or edge conditions. As seen in FIG. 1, the disclosed system may include a change trigger execution module 175, configured to identify a conversation change trigger through analysis of every user input, possibly in response to node processing.

The change trigger execution module 175 may execute a query to determine if an associated conversation change trigger exists in the conversation graph model. In some embodiments, checking for the associated conversation change trigger may comprise comparing the user input with any associated user input match criteria for the conversation change trigger stored in database 130 to determine if one or more tokens within the user input match one or more tokens stored within the user input match criteria.

This may result in three possible matching outcomes: In a first outcome scenario, the user input does not match a user input match criteria associated with the change trigger and/or an associated conversation context. In this scenario, node processing in the interrupted node resumes as normal. In a second outcome scenario, the user input matches the input match criteria associated with a single conversation context. In this scenario, a conversation change trigger is executed within a single node, separate from the interrupted node. In a third outcome scenario, the user input matches more than one input match criteria, and the system identifies, based on a highest confidence value, and executes the conversation change trigger with the highest confidence value.

Regardless of the result scenario described above, if one or more tokens in the user input match one or more tokens in the input match criteria, the node processing for the current node is intercepted and/or interrupted, and node processing continues in a separate node. By continuing node processing in a different node, the system adjusts to the change of flow for the conversation based on user input.

As noted in the results scenarios above, during node processing of a current node, the change trigger execution module 175 may determines if a trigger exists by attempting to match one or more tokens in the user input with one or more tokens stored in the input match criteria for a specific context change trigger. If so, the change trigger exists, and node processing at the current node may be suspended or stopped, and processing may continue at a different node in the graph.

In some embodiments, the node processing at the current node will never continue and finish after the point of interception. Instead, the conversation change trigger is executed, and the interrupted node's execution status changes from suspended to stopped.

If a conversation context change directive is specified in the conversation change trigger, server 110, possibly the change trigger execution module 175 may change the conversation context, as well as the associated existing data items (e.g., context or state variables) accordingly, and these data items may be updated, added and/or deleted, as necessary.

In the example non-linear graph execution described above, if the user input matches an input match criteria associated with a single conversation context (i.e., if a change trigger is fired and/or a conversation change trigger is executed), the conversation may continue at the graph node referenced by the conversation change trigger data, and the conversation immediately continues node processing at the referenced node. This “jump” from one node to another as specified by the conversation change trigger data make traversal through the conversation graph nonlinear. In some embodiments, no conversation change trigger data exists, or the conversation change trigger data may not include a target node reference. In this scenario, node processing resumes at the point of the interception within the interrupted node.

In some embodiments, conversation graph nodes may be specialized, analogous to the concept of class inheritance in programming languages. In a similar way, conversation nodes may have different specializations depending on context.

The node specialization execution module 180 may therefore implement a specialization resolution using abstract and specialized nodes defined within the conversation graph model, in order to determine the node to be executed. To accomplish this, server 110, possibly conversation graph execution module 165 or node specialization execution module 180 may execute regular conversation graph processing until it arrives at an abstract node within the conversation graph, which further includes multiple specialized nodes. The conditions within the software instructions of the specialized nodes may be evaluated and, in an error free scenario, one condition evaluates to true and the node related to that condition may be executed next.

In some embodiments, the node specialization execution module 180 may calculate a confidence value for each of the specialized nodes, based on the accuracy of the match between the user input and the user input match criteria (e.g., the number of tokens within the user input that match the tokens in the user input match criteria). The confidence value may reflect an indication of the quality of the match. The specialized node among multiple specialized nodes may be identified according to a highest confidence value.

If node interaction execution requires data from other systems that are not part of the conversation components (e.g. a bank's savings account fee schedule), external system access module 185 may implement integration functionality that supports communication with other systems, like a banking system (e.g., foreign currency exchange rate). This integration functionality may happen at any time during a conversation (e.g., during any node processing).

In embodiments that are single threaded, each conversation comprises a linear execution of nodes in a series. The order of this series is determined by the nodes selected and executed based on graph traversal. The disclosed system may therefore generate a history of the conversation according to this series of events, and make them available to system users (e.g., system administrators via a system administrator database). In some embodiments, the history starts with a start node, continues with several regular nodes (or error nodes, or subgraphs, if applicable), and ends with an end node (unless the conversation was abandoned, in which case, the history ends at the point of abandonment). A conversation history contains not only a linear series of graph node executions, but also the data collected from the user, the data provided to the user and any relevant intermediate data values created, which may have been relevant for edge selection (e.g., a history of conditions, contexts, state, etc.). Sufficient data is contained in the conversation history so that the conversation may be fully reenacted. Thus, an instance of each conversation graph instantiation may be stored in the graph instance base 150, upon completion.

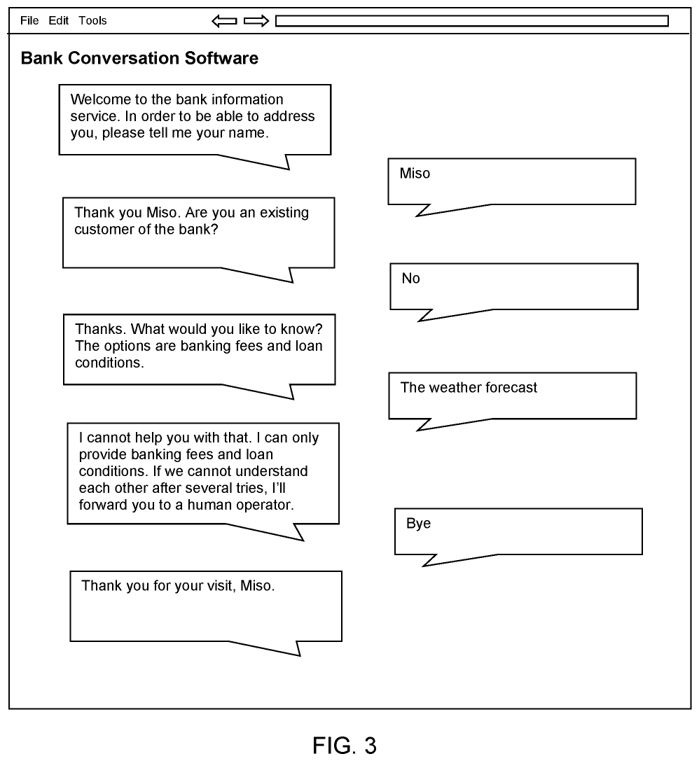

FIGS. 2 and 3 demonstrate non-limiting examples of a graph design GUI 155 and a user interaction GUI 160 respectively. These non-limiting example embodiments are the user interfaces for a banking application, comprising, for example, a desktop software, a software accessible through the bank's website using a web browser, an application on a smart client device, etc. Although the non-limiting examples such as those shown and described in association with FIG. 3 are represented as user interaction via a GUI, it is important to note that these examples are non-limiting. As another non-limiting example, a user may access the disclosed system via a voice application, wherein the user may hear the prompts from the system, and respond vocally. In such a system, server 110 may analyze the vocal response(s) of the user, and proceed according to steps analogous to those described herein for GUi-based embodiments.

This banking application may be designed to include a conversation interface, such as that seen in FIG. 3, allowing the system to greet the user, determine the user's purpose in accessing the system, and execute the user requests, if possible. This non-limiting example assumes a system including a natural language processing (NLP) component, capable of processing user input and system output without problems or errors. Non-limiting example purposes for which the user may access the system may include: asking general publicly-available questions regarding bank products and services (e.g., fee schedules, mortgage refinancing, etc.); registering with the system; providing user information to the system (name, address, bank account updates or other transactions, etc.); asking questions specific to the user status (e.g., anonymous user, bank customer, personal bank account customer, business bank account customer, etc.).

Continuing the example above, the banking application may be executed according to an underlying conversation graph structure, which determines the direction of the conversation between the user and the banking application. This conversation graph structure may be designed according to an ontology that defines multiple concepts (and/or instances; e.g., graph, node, edge, condition, context, trigger, etc.) and the relationships between the concepts (e.g., start-node, end-node, or error-node is_a node).

Continuing the example above, a conversation graph designer may access a graph design GUI 155, such as the non-limiting example seen in FIG. 2, and select a GUI component requesting to create a conversation graph. The system may receive a request from the graph designer, and execute a query to identify each of the concepts in the ontology, and generate a graphic representation of the concept within the graph design GUI 155 (e.g., links for graph, subgraph, node, edge, condition, context, and trigger in FIG. 2). The graph designer may then select (e.g., drag and drop) representations onto a provided palette within the graph design GUI 155 to create the graph model, creating the nodes, edges, conditions, contexts, triggers, etc. that direct the conversation.

The graph designer may then define node processing logic or instructions to take place in each node. In the non-limiting example embodiments seen in FIG. 2, the user generates a single start node. This start node includes node processing logic or instructions to generate and display a greeting to the customer, welcoming them to the application, and requesting an identifier (e.g., a name). In other words, node processing may include interactions between the system and the user, and the node processing for these interactions.

The start node may be a first node in the system, titled “Welcome Message” in FIG. 2, whose node processing logic includes software instructions to greet the customer and request information about a user (e.g., a name, a login or password, etc.). As a non-limiting example, this start node may include node processing logic to determine whether the user provides a name, and if so, evaluate one or more outgoing edges from the start node, making the start node a source node.

The second node in the conversation graph model, titled “Determine User Type” in FIG. 2, may distinguish between an anonymous user, in which case the system may select information designated in the system for anonymous users, and a customer of the bank, in which case the application may gather information from the user, such as their name or address, and if they are a customer of the bank, they may be asked to log into the system, possibly by providing a user name and password, for example, and provide banking information, such as account balances, etc.

As seen in FIG. 2, conditional node processing logic within the Determine User Type node may determine if user is customer or not. For the sake of simplicity, only two edges are outgoing from the Determine User Type node, but any number of edges could be outgoing from this node, and the node processing in the target nodes may depend on the condition in the source node.

The two edges are conditional upon whether the user is a customer or not. Thus, the source node may include a condition “if user is anonymous,” wherein the source node processing determines if the user is anonymous, and if so, follows the first edge to the Anonymous Customer node. Similarly, the source node may include a condition “if user is bank customer,” wherein the source node processing determines if the user is a bank customer, and if so, follows the second edge to the Bank Customer node. The conversation context for user type may be created or updated according to the user's input. In some embodiments, the user may need to login to demonstrate that they are a bank customer.

As seen in FIG. 2, conditional node processing logic within the Determine User Request node may determine the reason for the user's use of the system. The two edges are conditional upon the information requested by the user. Thus, the source node may include a condition “if request is banking fees,” wherein the source node processing determines if the request is for banking fees, and if so, follows the first edge to the Banking Fees node. However, this node may further include node processing logic that further determines whether the user is a bank customer or not, and adds or updates the context and the results of the request accordingly, specifically looking up and presenting fee data (e.g. fee agreements, fee schedule according to these agreements, current account or mortgage balances, accumulated fees, etc.), as shown in FIG. 2.

As seen in FIG. 2, each Customer Type could have its own set of conditions, outgoing edges, and/or branches. For example, a source node condition may include “if user is bank customer AND request is for banking fees,” this may lead to a target node that determines whether user's account is a personal or business account. Additional source node processing may include the conditions “if user has personal account” OR “if user has business account,” which would need to be resolved before looking up and presenting the appropriate fee data. The effect on the context should be noted in this example, since context data items may exist for both personal and business accounts, and thus the context data for the one is added to the other. In this scenario, if a user asks for a loan, the system may determine if the loan is for personal or business reasons before providing the fee schedule data. In other scenarios, the context data for one may replace the other, only requiring one fee schedule to be selected and presented.

Once all node processing is complete, the conversation model may proceed to an end node, the End Conversation node, responsive to a condition “if request is conversation termination,” possibly a question asking if the user needs anything else. When the end node processing for this node is complete, the system may end the conversation with the user.

As demonstrated in FIG. 2, each node may have several outgoing edges or branches, and may rely on other nodes or branches to complete the request, causing the graph to quickly become complicated. For this reason, the disclosed embodiments include a non-linear approach, which may also be demonstrated by FIG. 2.

As a non-limiting example, the start node may execute its node processing, and until the context changes, will assume that the user is anonymous. In this non-limiting example, the user may request fees and state that they are a bank customer at any time. Each node's processing may include instructions to analyze each user input to determine if the tokens within the user input cause a change trigger to fire. Thus, the users statement that they are requesting fees and are a bank customer will cause the conversation instance to execute a change trigger and continue at a different node than the current one, that determines if the user is a private or a business customer (and to provide a login and provide if not already complete.

Thus, in these embodiments, the nodes are not necessarily linear, and the processing within these nodes may be out of order, bypassing the need to receiving user input in a specific order and in response to specific questions, because the information is already provided by the user input. To accomplish this, the disclosed system analyzes the user input, and compares it with the context triggers to determine if context data is provided and the question is no longer needed, so that that node may be skipped.

As further demonstrated in FIG. 2, the graph may include one or more subgraphs, constructed through the user interface by the graph designer, using the appropriate GUI components to create a graph and subgraph.

In this non-limiting example, the user may add triggers for a subgraph. These subgraph triggers may not be connected to a specific node, so that the subgraph may be executed at any time and may apply to all nodes in the graph model, thereby bypassing nodes such as the greeting node, or nodes to complete the conversation.

As non-limiting examples in FIG. 2, the graph may include a Q&A subgraph for receiving questions from the user and providing answers at any time during the execution of the graph. In this subgraph, the user may ask any questions that the graph is capable of answering, and may repeat the process until all questions have been answered. The subgraph may then present a thank you message, and return to its point of origin and continue node processing at the appropriate node.

FIG. 3 demonstrates a conversation instance, possibly based on the conversation graph model shown in FIG. 2. In this conversation, the system greets the customer and asks for their name. After receiving their name, the system tries to determine the user type. After successfully doing so, the system tries to determine the user request. However, the user request is outside of the realm of the system's expertise, so the system recommends a connection to a human for customer service, possibly by executing a subgraph within the conversation graph model. FIG. 3 then demonstrates non-linear graph execution by recognizing from the word “bye” that the user wants to end the conversation, and “jumps” to an end node to end the conversation.

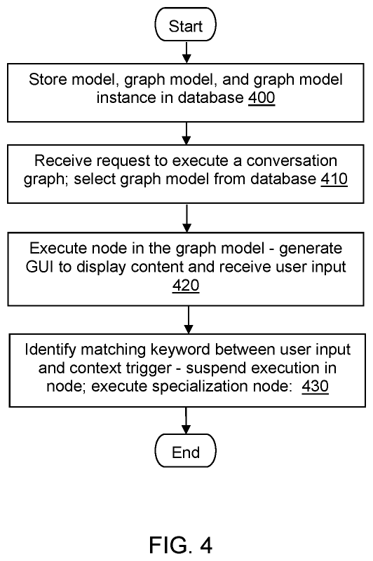

In summary, as shown in FIG. 4, the disclosed embodiments include a system comprising a database and a server. The server may be configured to store, in the database: a model comprising an ontology; a conversation graph model; and at least one conversation instance (Step 400).

The server may comprise a computing device coupled to a network and may further comprise at least one processor executing instructions within a memory which, when executed, cause the system to: receive, from a client device, a request to execute a conversation graph; select the conversation graph model from the database (Step 410); and execute a node within the conversation graph model, an execution of the node comprising: generating a Graphical User Interface (GUI) comprising: a first GUI component displaying a content; and a second GUI component receiving, from a user, a user input; transmitting the GUI to the client device for display; receiving, from the client device, the user input (Step 420); and executing a first software instruction in the node, based on the user input; identify at least one token within the user input; responsive to the at least one token matching a conversation context data associated in a database with the at least one token: suspend execution of the first software instruction; identify an abstract node associated in the database with the conversation context data; identify a specialized node associated in the database with conversation context data and the abstract node; and execute a second software instruction within the specialized node (Step 430).

Although the present invention has been described with respect to preferred embodiment(s), any person skilled in the art will recognize that changes may be made in form and detail, and equivalents may be substituted for elements of the invention without departing from the spirit and scope of the invention. Therefore, it is intended that the invention not be limited to the particular embodiments disclosed for carrying out this invention, but will include all embodiments falling within the scope of the appended claims.

What is claimed is:

1. A system comprising:
a database storing:
a model comprising an ontology;
a conversation graph model; and
at least one conversation instance;
a server comprising a computing device coupled to a network and comprising at least one processor executing instructions within a memory which, when executed, cause the system to:
receive, from a client device, a request to execute a conversation graph;
select the conversation graph model from the database;
execute a node within the conversation graph model, an execution of the node comprising:
generating a Graphical User Interface (GUI) comprising:
a first GUI component displaying a content;
a second GUI component receiving, from a user, a user input;
transmitting the GUI to the client device for display;
receiving, from the client device, the user input; and
executing a first software instruction in the node, based on the user input;
identify at least one token within the user input;
responsive to the at least one token matching a conversation context data associated in a database with the at least one token:
suspend execution of the first software instruction;
identify an abstract node associated in the database with the conversation context data;
identify a specialized node associated in the database with conversation context data and the abstract node; and
execute a second software instruction within the specialized node.

2. The system of claim 1, wherein the instructions further cause the system to:
identify, within the database, a plurality of specialized nodes comprising the specialized node and at least one additional specialized node;
determine a confidence value score for each of the plurality of specialized nodes; and
execute the at least one software instruction in a specialized node in the plurality of specialized nodes, selected based on its confidence value score.

3. The system of claim 1, wherein the instructions further cause the system to:
responsive to the at least one token not matching a conversation context data associated in a database with the at least one token:
complete processing of the first software instruction;
identify, within the conversation graph model, an edge associated in the conversation graph model database with the node and a target node stored in the conversation graph model;
identify, within the conversation graph model, at least one condition associated with the node;
responsive to the user input satisfying the at least one condition, execute a second software instruction within the target node.

4. The system of claim 3, wherein the instructions further cause the system to select the edge from a plurality of candidate edges associated in a knowledge model with the node.

5. The system of claim 1, wherein the instructions further cause the system to identify, as a result of an execution of the second software instruction:
a change in a node state associated with the first software instruction; or
a change in a conversation context associated with the second software instruction.

6. The system of claim 1, wherein the instruction further cause the system to:
generate a second GUI comprising:
a first GUI panel comprising at least one conversation graph management GUI component configured to create, read, update, or delete a conversation graph;
a second GUI panel comprising at least one conversation graph component GUI component comprising a node representation, a start node representation, an end node representation, an error node representation, and an edge representation;
a third GUI panel comprising a pallet onto which a second user may drag and drop at least one conversation graph component GUI component from the second GUI panel to generate at least one conversation graph;
transmit the second GUI to a second user device for display;
receive, from the second GUI, the at least one conversation graph; and
store the at least one generation graph in the database.

7. The system of claim 6, wherein the instructions further cause the system to generate, within the second GUI control panel:
a condition conversation graph component GUI component;
a context conversation graph component GUI component;
a trigger conversation graph component GUI component; and
a subgraph conversation graph component GUI component.

8. A method comprising the steps of:
receiving, by a server comprising a computing device coupled to a network and comprising at least one processor executing instructions within a memory, from a client device, a request to execute a conversation graph;
selecting, by the server, the conversation graph from a conversation graph model database;
executing, by the server, a node within the conversation graph, an execution of the node comprising:
generating a Graphical User Interface (GUI) comprising:
a first GUI component displaying a content;
a second GUI component receiving, from a user, a user input;
transmitting the GUI to the client device for display;
receiving, from the client device, the user input; and
executing a first software instruction in the node, based on the user input;
identifying, by the server, at least one token within the user input;
responsive to the at least one token matching a conversation context data associated in a database with the at least one token:
suspending, by the server, execution of the first software instruction;
identifying, by the server, an abstract node associated in the database with the conversation context data;
identifying, by the server, a specialized node associated in the database with conversation context data and the abstract node; and
executing, by the server, a second software instruction within the specialized node.

9. The method of claim 8, further comprising the steps of:
identifying, by the server, within the database, a plurality of specialized nodes comprising the specialized node and at least one additional specialized node;
determining, by the server a confidence value score for each of the plurality of specialized nodes; and
executing, by the server, the at least one software instruction in a specialized node in the plurality of specialized nodes, selected based on its confidence value score.

10. The method of claim 8, further comprising the steps of:
responsive to the at least one token not matching a conversation context data associated in a database with the at least one token:
completing, by the server, processing of the first software instruction;
identifying, by the server, within the conversation graph model database, an edge associated in the conversation graph model database with the node and a target node stored in the conversation graph model database;
identifying, by the server, within the conversation graph model database, at least one condition associated with the node;
responsive to the user input satisfying the at least one condition, executing, by the server, a second software instruction within the target node.

11. The method of claim 10, further comprising the step of selecting, by the server, the edge from a plurality of candidate edges associated in a knowledge model with the node.

12. The method of claim 8, further comprising the steps of identifying, by the server, as a result of an execution of the second software instruction:
a change in a node state associated with the first software instruction; or
a change in a conversation context associated with the second software instruction.

13. The method of claim 8, further comprising the steps of:
generating, by the server, a second GUI comprising:
a first GUI panel comprising at least one conversation graph management GUI component configured to create, read, update, or delete a conversation graph;
a second GUI panel comprising at least one conversation graph component GUI component comprising a node representation, a start node representation, an end node representation, an error node representation, and an edge representation;
a third GUI panel comprising a pallet onto which a second user may drag and drop at least one conversation graph component GUI component from the second GUI panel to generate at least one conversation graph;
transmitting, by the server, the second GUI to a second user device for display;
receiving, by the server, from the second GUI, the at least one conversation graph; and
storing, by the server, the at least one generation graph in the conversation graph model database.

14. The method of claim 13, further comprising the step of generating, by the server, within the second GUI control panel:
a condition conversation graph component GUI component;
a context conversation graph component GUI component;
a trigger conversation graph component GUI component; and
a subgraph conversation graph component GUI component.

15. A system comprising a server computer coupled to a network and comprising at least one processor executing instructions within a memory, the server being configured to:
receive, from a client device, a request to execute a conversation graph;
select the conversation graph from a conversation graph model database;
execute a node within the conversation graph, an execution of the node comprising:
generating a Graphical User Interface (GUI) comprising:
a first GUI component displaying a content;
a second GUI component receiving, from a user, a user input;
transmitting the GUI to the client device for display;
receiving, from the client device, the user input; and
executing a first software instruction in the node, based on the user input;
identify at least one token within the user input;
responsive to the at least one token matching a conversation context data associated in a database with the at least one token:
suspend execution of the first software instruction;
identify an abstract node associated in the database with the conversation context data;
identify a specialized node associated in the database with conversation context data and the abstract node; and
execute a second software instruction within the specialized node.

16. The system of claim 15, wherein the server is further configured to:
identify, within the database, a plurality of specialized nodes comprising the specialized node and at least one additional specialized node;
determine a confidence value score for each of the plurality of specialized nodes; and
execute the at least one software instruction in a specialized node in the plurality of specialized nodes, selected based on its confidence value score.

17. The system of claim 15, wherein the server is further configured to:
responsive to the at least one token not matching a conversation context data associated in a database with the at least one token:
complete processing of the first software instruction;
identify, within the conversation graph model database, an edge associated in the conversation graph model database with the node and a target node stored in the conversation graph model database;
identify, within the conversation graph model database, at least one condition associated with the node;
responsive to the user input satisfying the at least one condition, execute a second software instruction within the target node.

18. The system of claim 17, wherein the server is further configured to select the edge from a plurality of candidate edges associated in a knowledge model with the node.

19. The system of claim 15, wherein the server is further configured to identify, as a result of an execution of the second software instruction:
a change in a node state associated with the first software instruction; or
a change in a conversation context associated with the second software instruction.

20. The system of claim 15, wherein the server is further configured to:
generate a second GUI comprising:
a first GUI panel comprising at least one conversation graph management GUI component configured to create, read, update, or delete a conversation graph;
a second GUI panel comprising at least one conversation graph component GUI component comprising a node representation, a start node representation, an end node representation, an error node representation, and an edge representation;
a third GUI panel comprising a pallet onto which a second user may drag and drop at least one conversation graph component GUI component from the second GUI panel to generate at least one conversation graph;
transmit the second GUI to a second user device for display;
receive, from the second GUI, the at least one conversation graph; and
store the at least one generation graph in the conversation graph model database.
